(19) United States
(12) Patent Application Publication
(10) Pub. No.: US 2010/0217697 A1
(43) Pub. Date: Aug. 26, 2010

(54) System and Method for Providing a Cash Advance

(76) Inventor: Sean MacGuire, Key West, FL (US)

Correspondence Address: UNGARETTI & HARRIS LLP;INTELLECTUAL PROPERTY GROUP - PATENTS, 70 WEST MADISON STREET, SUITE 3500, CHICAGO, IL, 60602-4224, US

(21) Appl. No.: 12/579,056

(22) Filed: Oct. 14, 2009

Related U.S. Application Data
(63) Continuation of application No. 11/660,071, filed on Dec. 5, 2007, now abandoned.
(60) Provisional application No. 60/601,177, filed on Aug. 13, 2004.

(51) Int. Cl. G06Q 40/00; G06Q 30/00; G06Q 20/00; G06Q 50/00

(52) U.S. Cl. 705/34; 705/38; 705/39; 705/40; 705/41

(57) ABSTRACT

A loan system and cash advance product is provided which provides funds instantly to a financial institution or equivalent payment provider for pick-up by a registered user of the system. The user selects a cash advance product provided by an authorized distributor. The authorized distributor authenticates the user, pre-authorizes the purchase of the cash advance product, communicates with a loan system that verifies the user, authorizes the transaction, and transfers funds to the financial institution associated with the user. The authorized distributor then charges the user on his bill and remunerates the loan system cash advance product once the user has paid the bill.

### CROSS REFERENCE TO RELATED APPLICATIONS

This application is a continuation of co-pending application Ser. No. 11/660,071 filed on Dec. 5, 2007, which claims priority from PCT Application No. PCT/US2005/028508, filed on Feb. 10, 2005, now completed, which itself claims priority from U.S. Provisional Application No. 60/601,177, filed on Aug. 13, 2004. These applications are incorporated by reference herein.

### FIELD OF THE INVENTION

The present invention relates generally to the field of telecommunications and more specifically to a system and method for providing loans and cash advances.

### BACKGROUND OF THE INVENTION

Consumers sometimes find themselves short of cash at a time where they need to make a necessary purchase. Although many have access to bank overdrafts, lines of credit, and credit cards, they may have exhausted the credit provided by such means and furthermore, many consumers do not have such formal arrangements at all.

Those consumers who both need more than a minimum amount, such as $100, and meet certain minimum income and employment requirements can apply for a deposit-deferred loan from a pay-day loan company, provided they live in an area where these businesses exist. Pay-day loan applications require the consumer to provide a post-dated cheque made out to the pay-day loan company for the full amount to be repaid. In addition to the personal cheque, a recent bank statement showing direct deposits, and the last 2 pay stubs as proof of employment may be required. Deposits can then take up to 3 days to appear in the consumer's bank account. These loans, in addition to being slow and cumbersome to apply for, often come with an interest rate APR (Annual Percentage Rate) often starting at over 300% and sometimes exceeding 1300%.

Such systems have come under fire because of their apparent predatory nature which appear to encourage consumers to abuse such pay-day loan systems by “rolling over” their loans, which refers to only paying interest and service charges, and taking out a new loan every pay-day. This situation often causes the consumer to become further and further in debt to the extent that the interest and charges they pay may well exceed the amount of the original loan.

Consumers who need less than this minimum amount, or don't qualify or have access to pay-day loans, have even fewer alternatives. In fact, the only businesses they can turn to are pawnbrokers, where they would deposit something of value as security against a small loan. Other than that, they are forced to turn to family, friends, and co-workers for help. If the consumer wishes to acquire the money anonymously or feels embarrassed about the need to borrow such a small loan, this method of acquiring cash is not sufficient.

For companies considering the business of providing small cash advances, there are a number of problems. Generally speaking it is not worth granting small cash advances to customers because the rate of return is quite low when compared to the risk and trouble involved. It is likewise difficult for many companies to ascertain the creditworthiness of the applicants and costly to pursue those who choose not to repay the debt. Finally, few companies are structured in such a way as to have cash on hand to loan out. This is why the only currently existing commercial alternative is a pawn shop.

With the emergence of electronic commerce (E-commerce) and the Internet, many financial transactions are being dealt with in an automated and expeditious manner. The use of the Internet has been incorporated into many infrastructures which facilitates administrative support of such infrastructures similar to what is shown in the U.S. Pat. No. 6,658,568 to Ginter et al. Systems such as those described by Ginter et al. are typically used for complicated inventory systems and clearinghouse entities and do not provide a method for providing cash advances or other loans.

Other systems such as that described in a United States Application No. 2002/0111901 A1 to Whitney provide a method for servicing loans. This system deals with the transactions of goods and services and must take into account the risk of extending such a loan to facilitate these transactions. The system must provide an approval for collateral and generally are concerned with transactions and thus loans of greater quantities.

There are systems intending to provide access to cash such as that shown in the U.S. Pat. No. 5,367,561 to Adler et al. Adler et al. teach to provide an integrated system that allows a customer to receive a small loan billable to themselves which can be paid later. This type of system is suitable for a hotel wherein the customer can pick up funds from a hotel desk clerk. A method such as this does not allow a trusted relationship to extend beyond the immediate system for instance after the user checks out of the hotel.

Systems do exist that allow for financial transactions to be executed by a consumer using a pre-existing relationship with a trusted third party to approve such a transaction. For example United States Patent Application No. 2003/0135434 A1 to Jain provides a system and method for making micro-payments. Micro-payments are intended to pay for small charges incurred typically on the Internet. These charges can arise from downloading software such as music or other media files. Jain teaches to use a micro-payment system for transacting between a user and a merchant with a payment provider billing the user and subsequently paying the micro-payment system. This method requires registration of both the merchants and the users and intends to avoid the use of cash since it provides the means to pay for goods and services through an existing bill.

The method incorporated by Jain provides the compensation to the merchant after it receives payment from the payment provider. This is not suitable for instant loans since the micro-payment system would not provide funds until the payment provider could pay them which would not occur until the user had paid the payment provider. Therefore such a method is only suited for an environment in which all parties operate under a pay-later scheme wherein they collect the funds due at the end of the month.

Therefore a need has arisen for a system and method which eliminate or reduce the problems associated with prior methods of both granting and obtaining small cash advances. A loan system is required that is automated, simple to use, widely available, and can provide access to the cash advances instantly with a simple way to repay the cash advance. It should allow a cash advance to be purchased much like any other product available for sale. It is a further need for a system to be both fraud resistant and help users control their own abuse of credit. In addition, a system is required that does not need extensive, expensive, or complicated changes to current infrastructures to implement. Finally, a system is required that can provide a means for non-traditional lenders to be able to provide a cash advance product to their customers.

### SUMMARY OF THE INVENTION

It is therefore an aim of the present invention to provide a method for providing a cash advance to a customer of a cash advance distributor.

It is also an aim of the present invention to provide a system for implementing the above method for providing a cash advance.

More specifically, in accordance with the present invention, there is provided a method for providing a cash advance to at least one user, the method comprising the steps of:
a) having the user initiate a cash advance request from a cash advance distributor, the user being a pre-established customer of said given cash advance distributor and receiving service bills therefrom;
b) communicating said cash advance request to a loans provider;
c) transferring a cash advance amount consistent with said cash advance request from a loans account of said loans provider to a user account; and
d) charging the user, on a future one of said service bills, a loan charge corresponding to at least said cash advance amount.

Still in accordance with the present invention, there is provided a cash advance system for providing a cash advance to at least one user of the system, the user initiating a request for the cash advance using a user communication device, the system comprising at least one cash advance distribution system of a given cash advance distributor communicatively configured to receive the request from the user communication device, at least one loan system in communication with said cash advance distribution system communicatively configured to respond to the request and transfer a cash advance amount consistent with the request from a loan system account to a user account and an automated billing system for charging the user a loan charge corresponding to at least said cash advance amount, wherein the user is a pre-established customer of said given cash advance distributor and receives service bills therefrom such that said billing system may charge the user said loan charge on a future one of said service bills.

Further in accordance with the present invention, there is provided a computer implemented method for providing a cash advance to at least one user using a user communication device, the method to be implemented over at least one communication network by a cash advance system adapted for communicating over the network, the cash advance system comprising at least one cash advance distribution system and at least one loan system, the method comprising the steps of:
a) initiating a cash advance request by establishing a communication link over the network between the user communication device and the cash advance distribution system of a given cash advance distributor, the user initiating said cash advance request being a pre-established customer of said given cash advance distributor and receiving service bills therefrom;
b) communicating said cash advance request to said loan system;
c) automatically initiating an electronic transfer of a cash advance amount consistent with said cash advance request from a loan system account to a user account; and
d) charging the user on a future one of said service bills a loan charge corresponding to at least said cash advance amount.

Still further in accordance with the present invention, there is provided a method of providing a cash advance product to an individual, the cash advance product being provided through a given cash advance distributor of which the individual is an existing customer such that the given cash advance distributor comprises pre-established charging means for charging the individual for the cash advance product, the method comprising the steps of:
a) having the individual request a cash advance product from the given cash advance distributor;
b) communicating said request to a cash advance provider;
c) transferring the cash advance product from a cash advance provider's account to an user account of the individual; and
d) charging the individual using the pre-established charging means a cash advance charge corresponding to at least said cash advance amount.

Other aims, objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a block diagram showing the elements in a cash advance system in accordance with the present invention;

FIG. 2 is a schematic representation of the cash advance system of FIG. 1 using a telephonic infrastructure;

FIG. 3 is a flowchart showing a registration procedure for an authorized distributor;

FIG. 4 is flowchart showing a registration procedure for a customer;

FIG. 5 is a flowchart showing a procedure for modifying the customer's preferences;

FIG. 6 is a flowchart showing the steps involved in requesting a cash advance product;

FIG. 7 is a schematic representation of a cash advance product selection using the telephone;

FIG. 8 is a schematic representation of a cash advance product selection using a television pay-per-view system;

FIG. 9 is a schematic representation of a cash advance product selection available online using the Internet;

FIG. 10 is a flowchart showing the steps performed by the authorized distributor upon completion by the customer of the steps shown in FIG. 6; and

FIG. 11 is a flowchart showing the steps performed by a loan system when presented with a purchase request from the authorized distributor during the steps shown in FIG. 10.

### DESCRIPTION OF ILLUSTRATIVE EMBODIMENTS

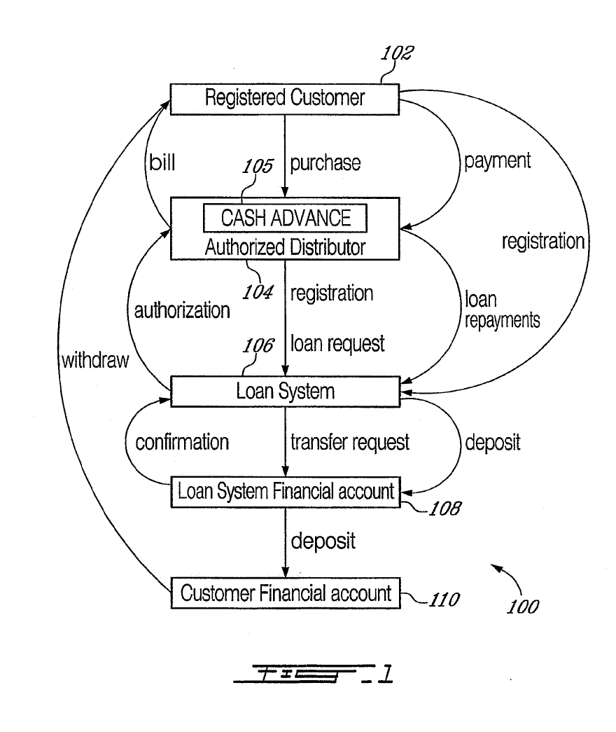

Referring therefore to FIG. 1, a cash advance system 100 is generally comprised of a registered customer (customer) 102, an authorized distributor (distributor) 104 whom distributes a cash advance product 105, a loan system 106, a financial account belonging to the loan system (loan system account) 108 and a financial account or service associated with the customer (customer account) 110. The components of the cash advance system 100 interact in various ways to register and provide the cash advance product 105 to the customer 102.

The customer 102 interacts with the distributor 104 to requisition a purchase for the cash advance product 105 and to facilitate payment for the cash advance product 105. The customer 102 also interacts with the loan system 106 for registration purposes and with the customer account 110 to redeem the cash advance product 105 for cash. The distributor 104 also interacts with the customer 102 for billing purposes and furthermore interacts with the loan system 106 for registration, for submitting loan requests, which may be pre-authorized by the loan system 106, and for repaying for the cash advance product 105 upon payment from the customer 102. The loan system 106 also interacts with the distributor 104 for sending transaction number authorization and interacts with the loan system account 108 for requisitioning the transfer of funds to the customer account 110 and for depositing funds upon payment from the distributor 104. The loan system account 108 also interacts with the loan system 106 to provide confirmation on the transfer of funds. Finally, as noted above, the customer account 110, receives a deposit from the loan system account 108 to enable the customer 102 to redeem the cash advance product 105 for cash immediately available to them.

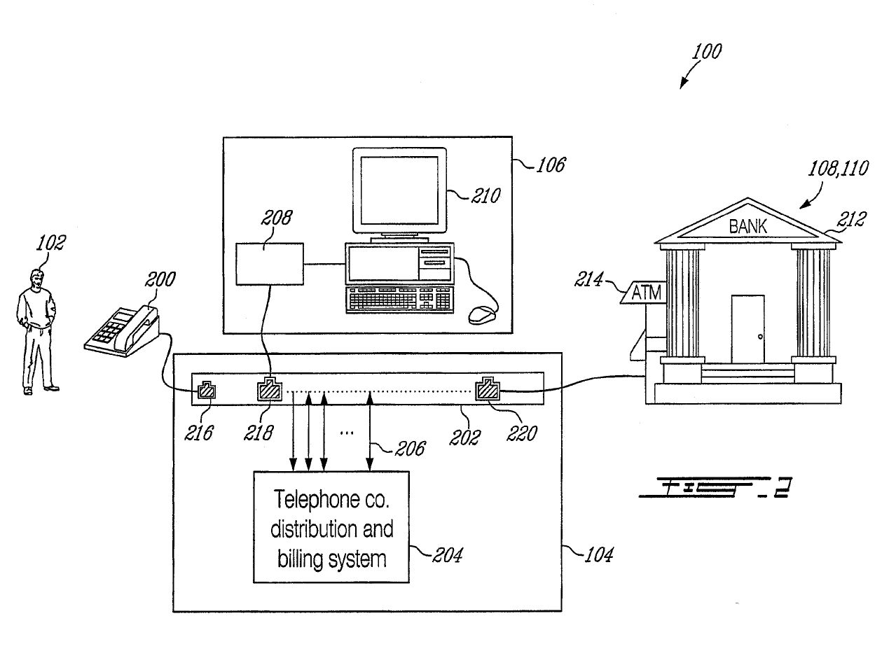

The cash advance system 100 described above can be implemented in any number of ways. For instance, as will be discussed further hereinbelow, the system 100 can be implemented using various communication infrastructures and devices, possibly interconnected through various communication and data transfer networks, that offer a number of user and operating interfaces to process and transfer system and user information (data) between the different parties partaking in the implementation of the cash advance system 100. For the purpose of illustration, the cash advance system 100 is described hereinbelow using a telephonic infrastructure, as shown in the illustrative embodiment of FIG. 2. As will be apparent to a person of skill in the art, other system and communication infrastructures, common to landline and wireless communication network systems and the like, may also be considered to implement the cash advance system 100 without departing from the general scope and nature of the present disclosure.

According to the illustrative embodiment of FIG. 2, the customer 102 uses a user communication device, such as a telephone 200, to register and order the cash advance product 105 which was shown in FIG. 1. Note that any type of telephone or communication device may be considered in this embodiment to execute the functions listed below, including, but not limited to, landline phones, analog and digital cellular telephones, hybrid PDAs and the like. Also, though many of the customer registration, authorization and loan system activation procedures, as described hereinbelow, may be implemented electronically using the communication device 200, the person of skill in the art will understand that various hardcopy forms and documents may also be used by the various parties involved in the cash advance system 100 to process such registration, authorization and activation procedures. Under certain circumstances, or in certain jurisdictions, it may be preferable or necessary for the customer 102 to sign and return various hardcopy documents such as disclosure notices, application forms and/or contracts to the loan system(s) 106 and/or distributor(s) 104 prior to being permitted to access the cash advance system 100. This example and other such examples should be apparent to a person of skill in the art and are not considered to extend the general scope and nature of the present disclosure.

The loan system 106, generally configured to manage various loan access and disbursement functions as listed below, is comprised of a computing system 210 connected to a router 208 communicatively configured to interact with the various other data communication and processing devices and infrastructures of the system 100. The computing system 210 of the loan system 106 may also be comprised of one or plural memories such as RAM and ROM to store and facilitate the implementation of loan process instructions and system software, as well as store various user, distributor and loan financial information in organized data structures such as system databases and the like. The computing system 210 may also comprise one or plural processors having access to the system memories and configured to implement the various system software and loan process instructions maintained thereon and discussed further hereinbelow, as well as a communication interface adapted to communicate, through the router 208, with the various data processing and communication devices of the system 100. Other known computing system components and peripherals may also be comprised in computing system 210 and should be apparent to a person of skill in the art.

Still referring to FIG. 2 the customer account 108 and loan system account 110 may include bank accounts governed by a bank branch 212 which provides an automated teller machine (ATM) 214 for dispensing cash. In this illustrative embodiment, the bank branch 212 is also equipped with the necessary data processing and communication equipment to electronically execute, when instructed by the loan system 106 and/or loan distributor 104, various data and cash advance transfers between the customer account 108 and the loan system account 110. Such equipment may include various servers having access to a number of account information databases and providing authorized users a secure connection thereto to implement the various data and cash advance transfers requested through the cash advance system 100. A person of skill in the art will understand that various bank branches, as well as other types of financial and banking institutions may also be considered to interact directly or indirectly with the system 100 to secure the requested cash advances using various computer implemented hardware, software and/or communication infrastructures known in the art.

As stated hereinabove, the distributor 104 in this illustrative embodiment is a telephone company illustratively comprising a cash advance distribution and billing system 204 communicatively interfaced with a communication infrastructure (infrastructure) 202 through a communications bus 206. As with the loan system 106, the distributor's system 204 is also generally comprised of various data processors and system memories, such ROM and RAM storing and providing access to various user and account information, cooperatively configured to maintain and implement various loan and billing instructions, discussed further hereinbelow, programmed in distributor software residing on the system 204. As stated above, communications and data transfers between the system 204 and the rest of the cash advance system 100, namely the loan system 210, the user's communication device 200 and the bank branch 212, as well as the implementation of various cooperative processes necessary to the processing of a given loan request, are channeled through the bus 206 and communication infrastructure 202.

As such, the infrastructure 202 generally enables the transfer of data through the system 100 allowing the registration of customers 102 and distributors 104 as well as the purchase of the cash advance product 105 and the transfer of funds between the loan system account 108 and the customer account 110. The telephone 200 is connected to the infrastructure 202 at 216, the loan system 106 is connected at 218 and the bank branch 212 and ATM 214 are also connected at 220.

The computing system 210 of the loan system 106 accesses the infrastructure 202 through the router 208 at 218. The router 208 allows the loan system 106 to communicate with the other elements of the cash advance system 100 by allowing both the reception and transmission of multiple signals simultaneously. The connections at 218 is illustrated as a single connection but it will be appreciated that the router 208 may provide as many individual connections as required. The communication bus 206 allows the cash advance distribution and billing system 204 of the distributor 104 to facilitate the purchase of the cash advance product 105 by the customer 102 and to facilitate billing and registration of the customer 102 as well as repayment to the loan system 104.

A person of skill in the art will understand that the infrastructure 202 may be comprised of one or plural communication infrastructures and networks cooperatively transferring data between the various parties of the system 100. Though the illustrative embodiment of FIG. 2 suggests the use of a telephonic infrastructure, which may encompass and be implemented on any type or combination of landline and/or wireless communication networks such as a PSTN, an analog and/or a digital cellular network (GSM, CDPD, UMTS, etc.), a DSL cable network and the like, other communication devices and infrastructures may also be considered to provide an equivalent system and cash advance service. As will be presented hereinbelow, alternative cash advance systems may include Pay-per-view cable and/or satellite broadcast systems accessed through a user's television set or the like, Internet and/or Web based communication systems accessed through a user's landline or wireless Web/Internet enabled computing device (PC, laptop, PDA, cellular telephone) and other such systems configured to provide remote access to the cash advance system 100.

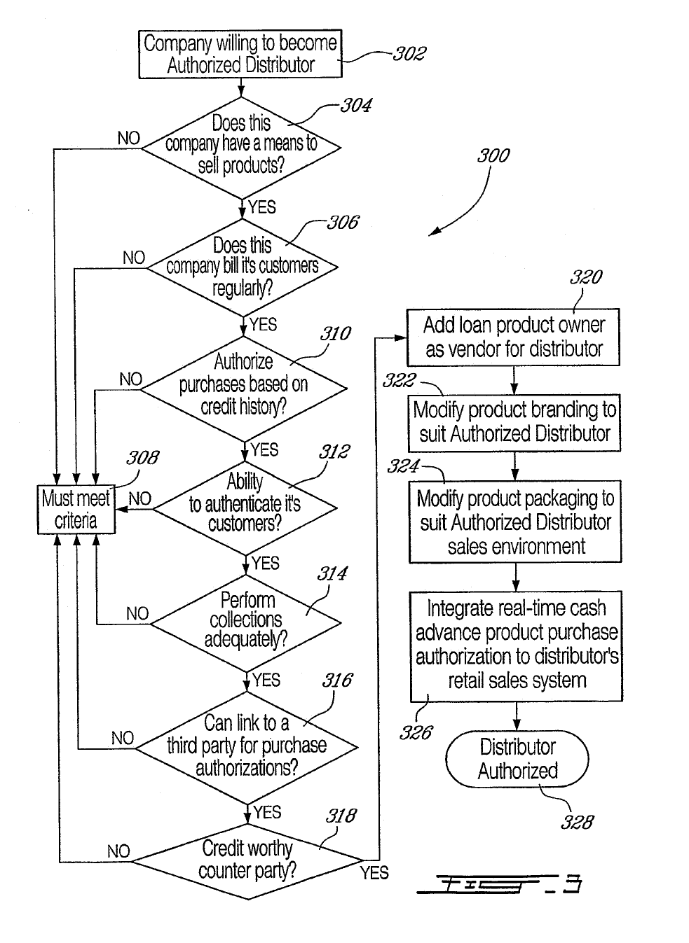

For the cash advance system 100 to operate, registration must have occurred with both the customer 102 and the distributor 104. A distributor registration procedure 300 is shown in FIG. 3 which is the procedure taken by a distributor to become an authorized distributor of the cash advance product 105. The registration begins with a company's interest in becoming a distributor 302. The registration procedure 300 can be accomplished in any way suitable to the loan system 106 as long as the distributor 104 can prove to the loan system 106 that they satisfy the criteria presented during the registration procedure 300. For illustrative purposes, it will be assumed that the registration procedure 300 is completed by the distributor 104 submitting a set of documents addressing the criteria presented and the loan system 106 processes these documents. In this example, a telephone company submits the documents for registration 300. It will be understood that such a registration process may also be automated by standardizing the authorization criteria and implementing the registration procedure through dedicated software configured to assess information provided by a given potential distributor and decide whether authorization should be granted based on this information.

Still referring to FIG. 3, if the company is willing to become an authorized distributor 302, the documents are submitted and the loan system 106 will first determine whether or not the company has a means for selling the cash advance product 304. If there exists no means for selling the cash advance product 105 then the company is notified that it does not meet the registration criteria 308. In the case of the telephone company, they can charge a customer 102 for services, whereby they can also sell the cash advance product 105, and criterion 304 is met.

The next criterion is whether or not the company bills their customers regularly since the loan system must be repaid by the company 306. If the company does not bill regularly then they are informed that they do not satisfy the registration criteria 308. In the case of the telephone company, it is well known that they perform monthly and/or bimonthly billing therefore they would satisfy criterion 306.

The next criterion involves credit information 310. If the company cannot assess the credit information of their customers they are informed that they do not meet the registration criteria 308. In the case of the telephone company, the pre-existing relationship involves knowing their customer's credit and therefore they would satisfy criterion 310.

The next criterion is whether or not the company possesses a means to authenticate its customers 312. If the company cannot sufficiently authenticate its customers they are informed that they do not meet the registration criteria 308. In the case of the telephone company, they have an automatic number identification (ANI) procedure which can cross reference an incoming call with the name and address associated with that phone number and therefore would satisfy criterion 312.

The next criterion is whether or not the company can adequately perform collections of outstanding debts from their customers 314. If the company does not collect outstanding debts, they are informed that they do not meet the registration criteria 308. In the case of the telephone company, they have a history of being able to collect debts through their monthly billing and/or collection agencies, and therefore they would meet criterion 314.

The next criterion is whether or not the company can link to a third party for purchase authorizations 316. If the company cannot provide this means for authorizing purchases, they are informed that they do not meet the registration criteria 308. In the case of the telephone company, they can authorize purchases by credit card which requires linking to a third-party for purchase authorizations, and therefore they would meet criterion 316.

Finally, with all of the above criteria satisfied, the loan system 106 will then assess the creditworthiness of the company 318. If they do not meet the minimum credit worthiness standards then they are informed that they do not satisfy the registration criteria 308. In the case of the telephone company, it can be assumed here that the telephone company is reputable and therefore would satisfy criterion 318.

By meeting the above criteria, the telephone company is then added to the list of authorized distributors of the cash advance product 320. Next, the cash advance product 105 is modified to suit the distributor 322. In the case of the telephone company, the cash advance product 105 is sold via toll free phone numbers. If necessary, the product is packaged for the environment in which it will be sold 324. In a virtual environment, such as purchasing via a toll-free number, the packaging will be in the form of an advertisement to indicate the toll-free numbers associated with the various cash advance products 105 being of varying incremental values. Next, the loan system 106 co-ordinates a real-time purchasing and authorization system with the company 326. In the case of the telephone company, the ANI, billing system, communication bus 206 and infrastructure 202 are adapted to communicate with the router 208 to ultimately be processed by the computing system 210 of the loan system 106. Finally, the registration procedure 300 is complete and the distributor 104 is authorized by the loan system 328.

The telephone company is now considered a distributor 104 and may allow the purchase of the cash advance product 105 using their pre-existing infrastructure 202 and the relationship established with the loan system 106. It will be appreciated that the above registration procedure 400 is applicable to any company willing to become an authorized distributor 104 and the process shall not be limited to what was described in the case of the telephone company. Further, though the above description considers a relationship between an authorized distributor 104 and a loan system 106 illustratively managed and operated by separate companies or organizations, the distributor 104 and loan system 106 may also be operated under the management of a same company. In this alternative embodiment, a distributor authorization process is not required as the distributor, in the above example a telephone company, manages both the distribution of loans, namely through its regular operating phone service and billing system, and the loan system 106 through a dedicated loan service and bank transfer system. In this case and with reference to FIG. 2, the cash advance distribution and billing system 204 and the loan system 106 could interact directly as a single processing unit, or again as part of a same computerized system. Alternatively, both systems 204 and 106 could operate through a dedicated intranet or company network configured to communicatively link each system in view of implementing the cash advance process. For illustration purposes only, both systems 204 and 106 will be considered in the following disclosure to operate under the supervision of two independent companies/organizations.

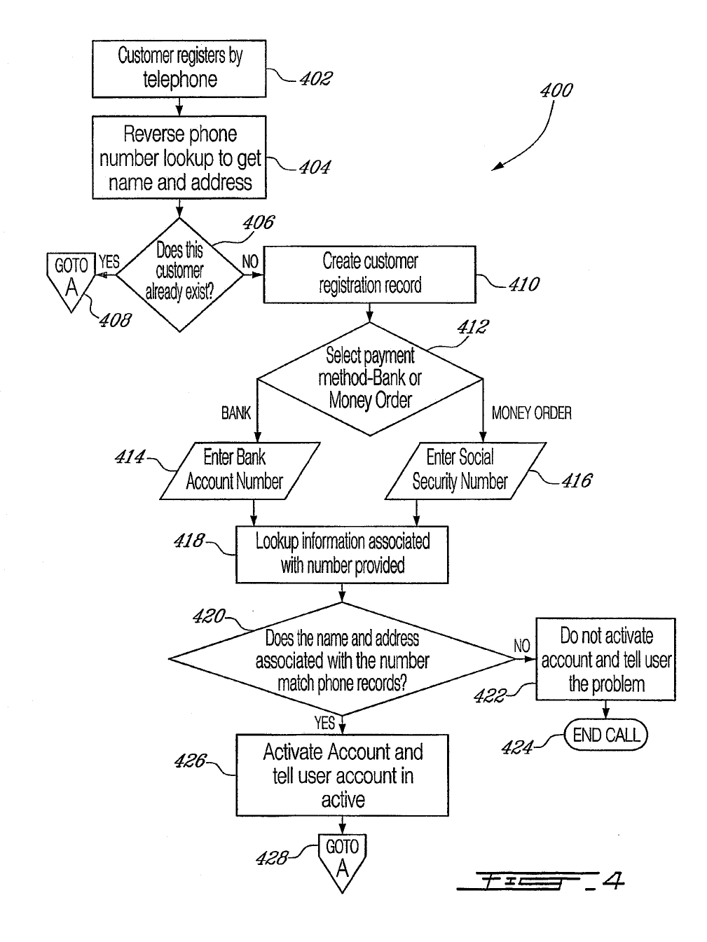

Referring now to FIGS. 2 and 4, to enable a customer to purchase the cash advance product 105 and receive a cash advance from the ATM 214, the customer must also participate in a registration procedure 400. The customer 102 begins by using his telephone 200 to dial a telephone number associated with customer registration 402 which is received through the infrastructure 202 by the router 208 and processed by the computing system 210. The phone number dialed is most conveniently but shall not be limited to a toll-free 1-800 service. Upon accessing the loan system 106 through the infrastructure 202, an automatic information look-up is done 404. Since the customer 102 in this example has used his home telephone 200, ANI is used to obtain the name and address of the person registered with that telephone number and in this case would be the customer 102. If the customer 102 is not using his home telephone 200, he may enter the home telephone number at step 404 for verification and an ANI procedure is used. Use of a customer-defined username, password and/or personal identification number (PIN) may also be considered at this point to identify the customer 102. Also, as presented hereinabove, the registration procedure 400 may be processed, in full or in part, using various hardcopy/paper forms and/or documents such as to obtain, for example, a customer's signature on a loan service agreement drafted to meet various legal requirements in a given jurisdiction.

Now that the loan system 106 has information associated with the caller it can check to see whether the customer 102 already exists in his system 406. If the customer 102 is already registered, the registration is bypassed and the customer 102 is re-directed to step A 408. Step A is the starting point in the customer preference procedure which will be explained following the registration procedure 400. If the customer 102 does not already exist, the loan system 106 creates a customer registration record 410 based on the information obtained at step 404. The customer is then asked which payment method he prefers 412 and must respond by entering a number on the keypad of the telephone 200 or by an interactive voice response (IVR) auditory method. The customer 102 will choose to either receive a deposit in his bank account or to receive a money order for pickup at a money order company.

A person of skill in the art will understand that other payment methods may also be considered without extending the scope of the present disclosure. Namely, the customer 102 may select to have the cash advance forwarded to an electronic smart card, wallet, purse or other such stored value device adapted for electronic transfer of funds thereto through any conventional or future landline or wireless communication system. For instance, the customer 102 may carry an electronic wallet adapted to communicate fund transfers through a wireless communication device (cellular phone, PDA, palmtop, laptop, etc.) and/or a landline device (PC, laptop, etc.) over conventional wireless and/or landline communication networks. Cash advance funds could then be transferred thereto by the system 100 and then used by the customer 102 to make a purchase. For the purpose of illustration, we limit this example to the two above payment methods, that is a direct deposit into a customer bank account or the purchase of a money order in the customer's name.

If the customer 102 chooses to have a bank deposit, a bank account number 414 could be entered and if he chooses to have a money order, the customer's social security number 416 could be entered for verification purposes. The loan system 106 may use an external verification agency to obtain the name and address associated with the bank account number or social security number 418 and attempt to match this information 420 with the name and address obtained in step 404. If the information does not match, the account is not activated and the customer 102 is notified of the rejection 422 and the call is terminated 424. If the information does match, the account is activated and the customer 102 is notified of the approval 426 and the loan system 106 re-directs the customer to step A. It will be appreciated that the collection of registration data can be done by any entity capable of sufficiently determining the identity of the customer 102 such as through interactive television (Pay-per-view channels, on-screen menus, etc.) or an internet service provider (ISP) and shall not be limited to the telephone. It will furthermore be appreciated that alternate means of user identification aside from a social security number may be used.

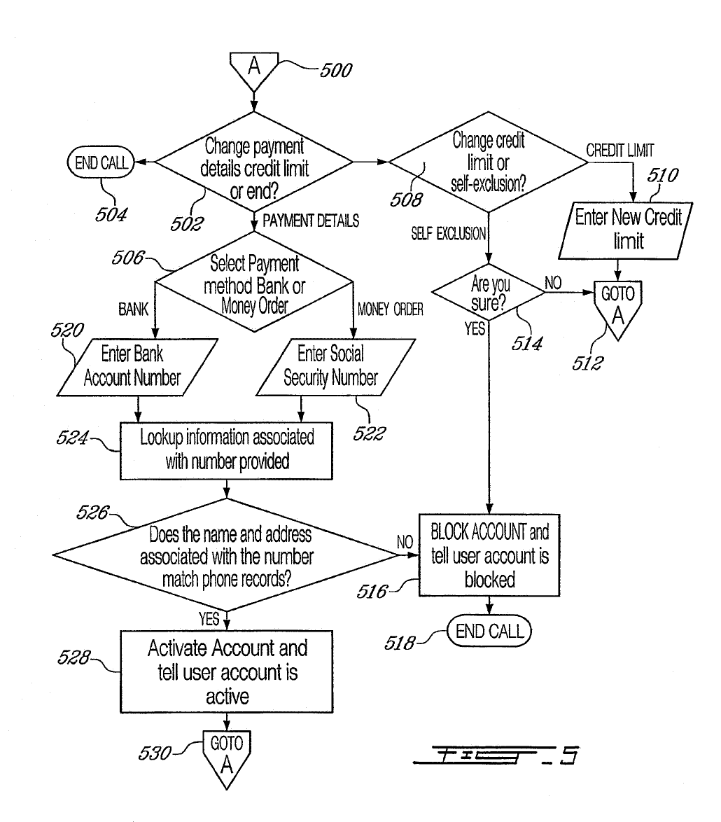

The customer preferences modification procedure commences with Step A 500 and is shown in FIG. 5. Step A 500 may occur through re-direction by the registration procedure 400 or may be accessed by the customer 102 at any time. If the customer 102 chooses at any time to change his preferences, ANI information is extracted to verify the customer 102 either directly from the incoming call made by the customer 102, or by having the customer 102 enter the telephone number of his account if he is not using his home telephone 200. If the system 100 is accessed remotely, the system 100 may also request the customer 102 to identify himself using a username and password, biometrics or again a personal identification number (PIN). This latter option may also allow access to the system 100 to more than one user for a given customer account. In the present example, this would allow different household members access to the cash advance system 100 through a same phone line account, each possibly having established his own specific user preferences and access limitations and optionally accessing separate loan accounts.

Still referring to FIG. 5, the registered customer 102 is asked to choose an option 502. These may include an option to change payment details 506, change his credit limit 508 or end the call 504 to name a few. Selection may be done using IVR or keypad selection similar to during the registration procedure 400. If he does not want to change any preferences, he may choose to end the call 504. If he chooses to change his credit limit 508 he is then asked whether he wants to modify the credit limit or to perform a self-exclusion. If the customer 102 chooses to modify his credit limit he is then asked to enter a new credit limit amount 510 and then the system returns to step A 512. If the customer 102 chooses to perform a self exclusion, he is warned that this will block his account from being used 514 and if he chooses “no” to this question he will return to step A 512. Otherwise, a message is played indicating that his account is blocked 516 and the call is ended 518.

If the customer 102 chooses to modify his payment details, he is then asked to select a payment method 506 and is given the choice of a bank account or money order payment method similar to during customer registration 400 (other payment methods may again be considered at this step). If he chooses a bank account, he is asked to enter his bank account number 520 and if he chooses a money order, he is asked to enter his social security number 522. Similar to during registration, the name and address associated with the number entered can be determined externally 524 and the loan system 106 determines whether the information matches the ANI information 526. If the information does not match, the loan system 106 assumes that the customer is trying to register an unauthorized account and he is notified that his account has been blocked 516 and the call is terminated 518. If the information does match, the account is re-activated with the new payment and/or credit limit preferences 528 and the customer 102 is re-directed to step A 530 wherein the process may be repeated or the call may be terminated 504.

As will be apparent to a person of skill in the art, the use of usernames, passwords and/or PINs to identify the customer, as discussed hereinabove, may reduce the need for an external verification of the user's authorization using the ANI information and allow, for example, remote access to the system 100 and multiple user access from a same customer account. In any case, whether customer identification is performed externally or internally, the customer's identification should be verified to limit unauthorized access to the cash advance system 100.

Now that the distributor 104 and the customer 102 have been registered with the loan system 106, the customer may purchase the cash advance product 105 from the distributor 104 to obtain cash from the ATM 214. The general steps involved in ordering the cash advance product 105 through the distributor 104 are shown in FIG. 6. The customer 102 may order the cash advance product 105 through any distributor 104 that is registered with the loan system 104 and the first step is for the customer 102 to select the cash advance product he desires 602. The distributor will typically offer a range of cash advance products 105 and for illustration purposes we will assume in this embodiment that the distributor 104 is offering cash advance products with values of $25, $50, $75 and $100. Once the customer 102 has selected the desired cash advance product, the distributor 104 through which the purchase is being made authenticates the customer 102 to establish the identity of the customer as a prerequisite to the purchase process step B 1000. The authentication is done by ANI in the case of the telephone or by other means such as through the internet protocol (IP) address of the customer 102 or through the cable or satellite address associated with the customer's interactive television service. Usernames, passwords and PINs may also be considered here to identify the customer. With this information obtained, the distributor 104 will go to step B 606, which is the first step in the distributor handling procedure explained below.

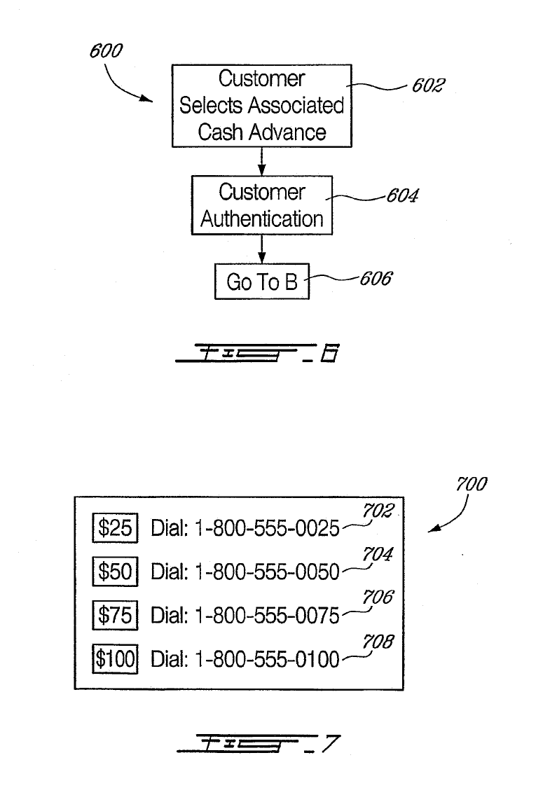

To illustrate how a customer 102 would order the cash advance product 105 according to FIG. 6, reference will be made to FIGS. 7 through 9. These figures illustrate three methods of ordering the cash advance product 105 via three different distributors 104 accessible through the use of respective types of user communication devices. Other systems implemented and accessed using other types and varieties of communication devices should become apparent to a person of skill in the art and should thus not be considered to extend the general scope and nature of the present disclosure.

If the customer 102 wishes to order the cash advance product 105 through the telephone company cash advance distribution and billing system 204, he could be presented with the options shown in FIG. 7. FIG. 7 shows a page in the telephone book 700 for which the distributor 104 is advertising the telephone numbers used to order various cash advance products 105. One number can be dialed for a $25 product 702, a separate number can be dialed for a $50 product 704, yet another separate number can be dialed for a $75 product 706 and finally a final separate number can be dialed for a $100 product 708. The customer 102 will dial the telephone number associated with the cash advance product 105 he desires from his home telephone 200, or again from any other telephone providing the customer enters his home telephone number, a username and password, and/or a PIN to identify himself and the account being used. Alternatively, the customer 102 could access the system 204 by dialing a single telephone number and select a desired cash advance amount through a dedicated IVR, or again by entering the desired amount using a telephone's keypad when prompted to do so by the system 204. Using this alternative ordering method, the user 102 could have access to a specific cash advance amount consistent with the customer's specific needs, rather than to a predefined set of cash advance amounts limited to $25, $50, $75, or $100.

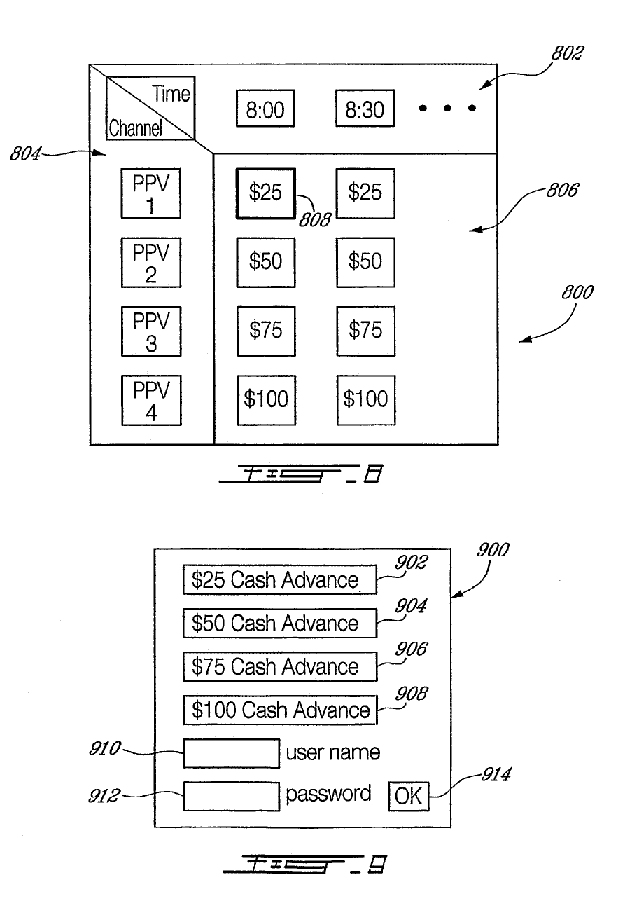

If the customer 102 wishes to order the cash advance product 105 through an interactive television service provided by a cable or satellite provider, he would be presented with the options shown in FIG. 8. FIG. 8 shows an interactive menu displayed on a television screen 800. The interactive menu 800 is generally partitioned into a grid pattern with a row of time indicators 802 along the top of the interactive menu 800 and a column of channel indicators 804 along the leftmost portion of the interactive menu 800. The remainder of the interactive menu 800 is a selection grid 806 which presents a different cash advance product 105 in each grid element based on a time and channel indication and the customer 102 can highlight a desired cash advance product 808 for selection using an interactive device such as a remote control. The customer 102 can select a cash advance product 105 from the interactive menu 800 and will be asked for an input for authorization purposes. This may include any method appropriate to achieve similar authentication as ANI using the telephone. Remote access could also be considered in this example with proper customer identification and verification measures implemented through the input of predefined usernames, passwords, PINs and the like.

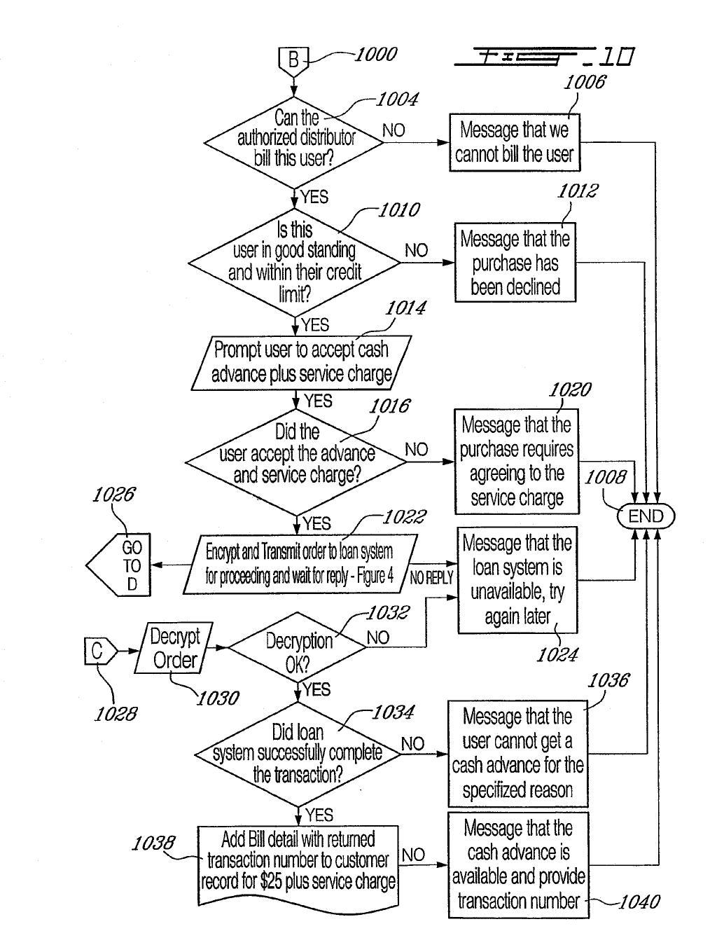

If the customer 102 wishes to order the cash advance product 105 through an online interface, he would be presented with the options shown in FIG. 9. FIG. 9 shows an interface 900 provided by a website accessed by a personal computer. The interface 900 allows the customer 102 to choose from a $25 product 902, a $50 product 904, a $75 product 906 or a $100 product 908. The customer 102 must also provide a username 910 and password 912 and select “OK” 914 to initiate the purchase. The username 910 and password 912 illustrates one method for authenticating the customer 102 but it will be appreciated that any method for matching a customer 102 to his appropriate account may be used. Again, the customer 102 may also be provided with the option of entering a specific cash advance amount that is not limited to the predefined set of cash advances. A specific cash advance request could be entered through the dedicated website interface 900 such that the customer 102 is not limited to selecting from a $25, $50, $75 or $100 cash advance.

To illustrate the purchasing procedure 600 shown in FIG. 6, it will be assumed that the customer 102 is using is home telephone 200 (FIG. 2) and will order the cash advance product 105 by dialing the $25 product phone number 702 provided by the page 700 in the telephone book (FIG. 7). The customer 102 has selected the $25 product 702 and therefore must dial the number indicated 602. The request is received by the distributor 104 through the communication bus 206 and is automatically processed by the system 204. The distributor 104 performs an ANI look-up in this case since the customer's home telephone 200 is used for authentication purposes 604. In other cases, the customer 102 may be asked to enter his home telephone number, a username, a password and/or a PIN if he is using another telephone. Now the process is directed at 606 to step B.

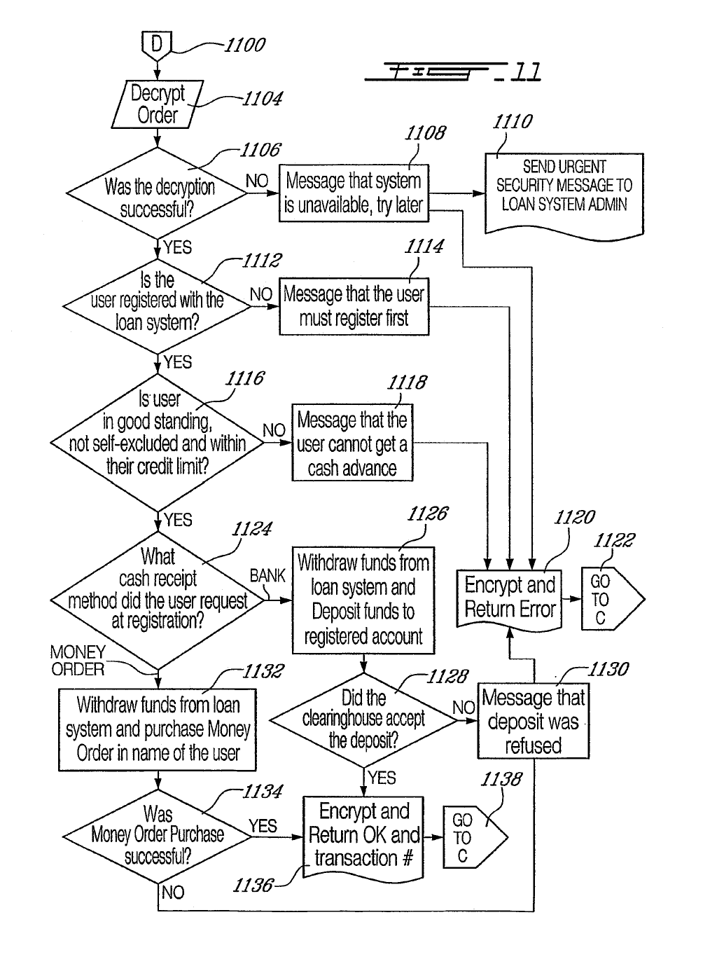

Referring now to FIGS. 2 and 10, step B 1000 begins once the distributor 104 has processed the ANI information and determines whether the originating phone number matches a phone number of an existing customer 1004. This is shown in FIG. 10. If the incoming phone number does not match, a message is given indicating that the customer 102 cannot be billed because he is not registered with the telephone billing system 1006 and the call is terminated 1008. If the distributor 104 can bill the customer 102, he will then check whether the customer' account is in good standing and/or within his credit limit 1010. In this example, the telephone company system 204 will check its records to determine the standing of the account. If the customer 102 is not in good standing, a message is given indicating that the purchase has been declined 1012 and the call is terminated 1008. If the customer 102 is in good standing and the purchase would not cause him to exceed his credit limit, the customer 102 is prompted to accept charges that amount to the value of the cash advance product 105, which in this case is $25 plus an additional service charge 1014. The amount that will be charged to the customer 102 is therefore at least the value of the cash advance product but will typically be greater than that value.

The distributor 104 will inform the customer 102 of a method for accepting the service charge, either through touching a particular key on the telephone 200 or using IVR and wait for a response 1016. If the customer 102 does not accept the service charge, a message is given indicating that the purchase requires acceptance of the service charge 1020 and the call is terminated at 1008. If the customer 102 does accept the service charge, the order for the cash advance product 105 is encrypted and transmitted to the loan system 106 and the distributor 104 will wait for a reply at 1022. If the loan system 106 does not reply, a message is played that the loan system 106 is unavailable and to try again later 1024 and the call is terminated at 1008. If the loan system 106 does reply, the transmission will commence and the procedure is re-directed to step D 1026 which is handled by the loan system 106. The re-direction occurs through the infrastructure 202 to the router 208 at the point 218 and is processed by the computing system 210 of the loan system 106.

Reference will now be made to FIG. 11 where step D 1100 begins by decrypting the incoming order 1104. The loan system 106 will next determine whether or not the decryption was successful at 1106. If the decryption was unsuccessful, a message is given at 1108 that the system is unavailable and an urgent message is sent to the administration of the loan system 106 notifying them of the decryption error (see 1110). If the decryption is successful, the loan system 106 will then determine at 1112 whether or not the customer 102 is registered. This is done through ANI and the matching process used by the loan system 106 during registration 400 (FIG. 4). If the customer 102 is not registered, a message is given at 1114 indicating that the customer must first register with the loan system, an error message is encrypted and returned to the distributor at 1120 and the procedure is re-directed to step C 1122 shown in FIG. 10.

If the customer 102 is registered, the loan system 106 then checks the customer's account information and preferences to determine whether or not his account is in good standing, has not been self-excluded and is within his approved credit limit (see 1116). If any of these questions results in a negative answer, a message is given at 1118 that the customer 102 cannot receive the cash advance product, an error message is encrypted and returned to the distributor at 1120 and the procedure is re-directed to step C 1122.

If the customer's account is in good standing (the questions posed at step 1116 are all positive) then the loan system 106 determines which payment method is used by the customer at 1124. If the customer 102 uses a bank deposit, the amount of the cash advance product 105, in this case $25 is withdrawn at 1126 from the loan system account 108 at the bank branch 212 (FIG. 2) and deposited in the customer account 110. The loan system 106 will wait for confirmation from the clearinghouse (in this example the bank branch 212) that the deposit was successful (see 1128). If the deposit was not successful, a message is given at 1130 that the deposit was refused, an error message is encrypted and sent back to the distributor at 1120 and the procedure is re-directed to step C 1122. If the deposit was accepted, a confirmation message is encrypted and returned to the distributor at 1136 and the process is re-directed to step C 1138.

A person of skill in the art will understand that the customer account 110 and the loan system account 106 may be maintained through separate banks and that various fund transfer mechanisms and/or intermediaries may be called upon to execute the transfers/deposits. In one example, the funds may be transferred by a clearinghouse communicatively configured for such transfers. One or plural clearinghouse(s) could be used to implement and confirm fund transfers in system 100 when plural banking and/or financial institutions are involved.

Referring back to step 1124, if the payment method indicated by the customer 102 was to use a money order, the amount of the cash advance product 105, in this case $25, is withdrawn 1132 from the loan system account 108 at the bank branch 212 (FIG. 2) and used to purchase a money order in the name of the customer 102 from the money order company. The money order company is an alternative to using a bank branch 212 and may be a company such as Western Union that processes money orders. The loan system 106 will wait for confirmation from the money order company that the deposit was successful (see 1134). If the deposit was not successful, a message is given at 1130 that the deposit was refused, an error message is encrypted and sent back to the distributor at 1120 and the procedure is re-directed to step C 1122. If the purchase of the money order for the customer was successful, a confirmation message is encrypted and returned to the distributor at 1136 and the process is re-directed to step C 1138. Other payment methods, as discussed hereinabove, may also be considered, the above steps also applying to these alternative payment methods when they are selected by the customer 102.

During the steps above, which are processed by the loan system 106, whether or not an error or confirmation ultimately occurs, the process is re-directed to step C found in FIG. 10. This re-direction occurs again through the infrastructure 202 and control of the process returns to the system 204 of the distributor 104 via the communication bus 206. Referring to FIGS. 10 and 11, either an encrypted error 1120 or an encrypted confirmation 1136 message returns back to the distributor 104 at step C 1028. The message received is then decrypted at 1030 and the distributor 104 determines whether or not the decryption was successful at 1032. If the decryption was unsuccessful, a message is given at 1024 indicating that the loan system is unavailable and the customer should try again later and the call is terminated at 1008. If the decryption was successful, the telephone company system 204 will add a charge to the customer's telephone bill in the amount of the $25 cash advance product 702 plus the service charge at 1038. A message is then given at 1040 that the cash advance is available in the customer account 110 and can be picked up at an ATM 214 or directly from the bank branch 212 and the call is terminated at 1008.

As mentioned hereinabove, the user 102 ultimately pays for the cash advance product upon reception of a future phone bill, on which a charge corresponding to the cash advance product 702 and the service charge (1038) will appear. Once the user 102 has repaid the distributor 104 for the loan service, the distributor 104 transfers corresponding funds to the loan system 106. As a result, the loan distributor 104 accepts minimal risks while the financial risk taken by the loan system 106 is greatly reduced by the reputation of the distributor 104 in enforcing bill payment from its customers.

It will be appreciated that if the customer 102 had chosen to receive payment in the form of a money order that the money order would be available at the money order company for pick up and that the bank branch 212 and ATM 214 described herein are only used for illustrative purposes. It will also be appreciated that customer account 110 may include any account which can dispense funds to the customer 102 and shall not be limited to a bank or money order company described herein. Other methods such as “cashing in” the cash advance product 105 directly at a merchant or other establishment may be appropriate based upon the implementation of the cash advance system 100 described herein as long as the customer 102 can be verified as a registered user of the loan system 106.

In addition, other payment options could include transferring a cash advance to a third-party account. For instance, a customer could select to take out a loan on their account and transfer the acquired funds to a friend or family member also registered with the system 100. Other such alternatives should be apparent to a person of skill in the art and should not be considered to extend the general scope and nature of the present disclosure.

It will also be appreciated that the cash advance product 105 can be purchased using any distributor 104 that is registered with the loan system 106 and shall not be limited to the telephone company and the telephone book page 700 shown in FIG. 7. These other purchasing methods may include but shall not be limited to the interactive television menu 800 provided by a cable or satellite provider shown in FIG. 8 or the website interface 900 provided by an ISP shown in FIG. 9.

Also, other possible purchasing methods may be provided, for example, through a dedicated Pay-per-view cash advance channel, supported by an authorized Pay-per-view entertainment producer. This alternative could rely on the pre-existing relationship that these content producers have with cable and satellite providers.

Further, the cash advance system 100 could be implemented through the use of service cards, somewhat like bank cards, protected by a user-specific PIN and useable as a debit card at participating ATMs, stores, restaurants and the like. Service cards could be available from a Point-of-Sale display, as a promotional handout or again distributed by mail by an authorized distributor when sending out bills to its customers. An interested customer could then call the number on the card and go through the authorization process, optionally selecting one or plural distributors through which loans could be billed and repaid. Once authorized, the card could be activated by entering the card number and choosing a PIN. To use the card, the customer could call the loan system, as in 106, enter the PIN number, select an amount of cash from an IVR menu and accept the service charge. Funds could then be transferred to the customer's bank account, a dedicated loans account maintained by the loan system 106 or the distributor 104, and/or accessible using the service card.

It will also be appreciated that the distributor 104 shall not be limited to a service provider capable of credit type billing but may also include merchants which can verify that the customer 102 is registered with the loan system 106 and can repay the loan system 106 upon collecting remuneration from the customer 102. In this case the cash advance product 105 may be in the form of a gift card, smartcard or other debit/credit device, but shall not be limited to such devices. For instance, loans could comprise physical items to be purchased at a checkout counter and paid in full, in cash or using a credit card, covering both the loan amount and the various relevant loan service and interest charges at the point of purchase. In this alternative embodiment, the cashier would charge the full amount of the loan service at purchase and give the corresponding cash advance amount to the user when requested. This could be used to convert stored value in gift cards and gift certificates to cash. A serial number on the box/card could be used to track the loan.

Ultimately, a relationship can be established between any given loan distributor 104, any given customer 102 of a given loan distributor 104 and a loan provider's loan system 106, providing both the given loan distributor and the given customer thereof meet their respective authorization criteria, as presented hereinabove. Through this relationship, the authorized customer 102 may gain access to quick cash advances for a reasonable fee and the authorized loan distributor 104 profits from the user loan service funds (pay-per-use charges, fixed rate charges, late charges, etc.) with minimal to no risk. The loan provider, reimbursed through the reputed authorized loan distributor's billing system, also assumes limited risks in implementing the loan system 106. In addition, the loan provider may request a fee from authorized distributors 104 to provide the loan service through their systems, request a partial remuneration from the loan service charges paid to each distributor 104 for each processed loan, or any other type of financial compensation.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. A method for providing a cash advance to at least one user, the method comprising the steps of
a) having the user initiate a cash advance request from a cash advance distributor, the user being a pre-established customer of said given cash advance distributor and receiving service bills therefrom;
b) communicating said cash advance request to a loans provider;
c) transferring a cash advance amount consistent with said cash advance request from a loans account of said loans provider to a user account; and
d) charging the user, on a future one of said service bills, a loan charge corresponding to at least said cash advance amount.

2. The method as claimed in claim 1, the method further comprising an authorization step, before step c), of evaluating said loan request based on a predetermined set of authorization parameters, only proceeding with steps c) and d) if said loan request satisfies said parameters.

3. The method as claimed in claim 1, wherein said user account comprises any one of a user or third-party user bank account, a money order account such that a money order may be purchased for said cash advance amount in a name of the user and an electronic stored value device.

4. The method as claimed in claim 3, wherein said user account comprises said user bank account and the cash advance is accessible to the user through an automated banking machine adapted to access funds from said user bank account.

5. The method as claimed in claim 1, the method further comprising a user registration step before step a), wherein the user first provides registration information to the loans provider to obtain an authorization to request a cash advance from said cash advance distributor.

6. The method as claimed in claim 1, the method further comprising a distributor registration step before step a), wherein a potential distributor first provides registration information to the loans provider to become an authorized cash advance distributor.

7. The method as claimed in claim 1, wherein the cash advance distributor and the loans provider are managed by a same company.

8. The method as claimed in claim 1, the method further comprising a step, after step d), of transferring a repayment amount corresponding to at least said cash advance amount from a cash advance distributor account to said loans provider account.

9. The method as claimed in claim 8, wherein said repayment amount is transferred only once the user has repaid said loan charge to said given cash advance distributor upon reception of said future one of said service bills.

10. The method as claimed in claim 1, wherein said cash advance distributor is a telecommunications service provider such as a telephone company, an internet service provider, a cable service provider, a satellite service provider, a wireless service provider or a Pay-per-view service provider.

11. The method as claimed in claim 1, wherein said cash advance distributor is a company providing its own store credit card, said service bills comprising store credit card bills.

12. The method as claimed in claim 1, wherein said cash advance distributor is a utility company such as a gas company, an electric company, a water company, an oil company or a natural gas company.

13. The method as claimed in claim 1, wherein said loan charge comprises said cash advance amount and a service charge amount.

14. A cash advance system for providing a cash advance to at least one user of the system, the user initiating a request for the cash advance using a user communication device, the system comprising at least one cash advance distribution system of a given cash advance distributor communicatively configured to receive the request from the user communication device, at least one loan system in communication with said cash advance distribution system communicatively configured to respond to the request from a loan system account to a user account and an automated billing system for charging the user a loan charge corresponding to at least said cash advance amount, wherein the user is a pre-established customer of said given cash advance distributor and receives service bills therefrom such that said billing system may charge the user said loan charge on a future one of said service bills.

15. The cash advance system as claimed in claim 14, wherein said given cash advance distributor is a telecommunications service provider such as a telephone company, an internet service provider, a cable service provider, a satellite service provider, a wireless service provider or a Pay-per-view service provider.

16. The method as claimed in claim 14, wherein said cash advance distributor is a company providing its own store credit card, said service bills comprising store credit card bills.

17. The method as claimed in claim 14, wherein said cash advance distributor is a utility company such as a gas company, an electric company, a water company, an oil company or a natural gas company.

18. The cash advance system as claimed in claim 14, wherein said loan system comprises a loan system bank account electronically maintained on a computerized banking system of a given financial institution communicatively accessible by said loan system.

19. The cash advance system as claimed in claim 14, wherein said user account comprises an electronic account maintained on an interactive device communicatively accessible by said loan system.

20. The cash advance system as claimed in claim 19, wherein said user account comprises any one of a user bank account or a third party bank account electronically maintained on a computerized banking system of a given financial institution, a money order account electronically defined on a computerized device at a money order distribution location, an electronic stored value device and a loans account electronically maintained on a dedicated computerized loans account system.

21-43. (canceled)
